(19) United States
(12) Patent Application Publication
(10) Pub. No.: US 2020/0304713 A1
(43) Pub. Date: Sep. 24, 2020

(54) Intelligent Video Presentation System

(71) Applicant: MICROSOFT TECHNOLOGY LICENSING, LLC, Redmond, WA (US)

(72) Inventors: David Yuheng ZHAO, Redmond, WA (US); Henrik TURBELL, Redmond, WA (US)

(73) Assignee: MICROSOFT TECHNOLOGY LICENSING, LLC, Redmond, WA (US)

(21) Appl. No.: 16/511,901

(22) Filed: Jul. 15, 2019

Related U.S. Application Data
(60) Provisional application No. 62/820,189, filed on Mar. 18, 2019.

(51) Int. Cl. H04N 5/232; H04N 5/262

(52) U.S. Cl. CPC H04N 5/23245; H04N 5/2621; H04N 5/232933; H04N 5/23218

(57) ABSTRACT

A method and system for providing an enhanced video stream includes receiving a video stream captured by a camera positioned to include a target in a camera field of view and entering a detection mode to detect the target in the received video stream, before detecting the target in the video stream. Upon detecting the target in the video stream, the method automatically switches from the detection mode to an enhancement mode configured to process the video stream to obtain an enhanced video stream of the detected target. The enhanced video stream is then presented for display on a display device, while a position of at least one of the camera or the target are monitored while presenting the enhanced video stream for display. The method and system then detects a change in the position of at least one of the camera or the target, and upon detecting the change in the position, automatically generates a signal to switch back to the detection mode and detect a position of the target in the video stream.

### CROSS REFERENCE TO RELATED APPLICATIONS

This application claims the benefit of priority to U.S. Provisional Application No. 62/820,189, entitled “Intelligent Video Presentation System,” filed on Mar. 18, 2019, the entirety of which is incorporated by reference herein.

### BACKGROUND

In recent years, there has been a significant increase in the use of virtual meeting applications to conduct meetings as more and more people work from home or collaborate with colleagues or other people remotely from different locations. The use of these applications enables participant to view each other and as such freely exchange ideas and information without the need to be in the same room.

In-person meetings often involve the use of a board (e.g., whiteboard, chalkboard, glass boards, etc.) to write or draw on to present some information. Participants in virtual meetings may also desire to make use of a physical board to write or draw on. Sometimes this is achieved by pointing the participant's camera (e.g., a webcam, a computing device's camera, etc.) toward a board available at the participant's current location to share the contents of the board with the other participants in the meeting. The presenting participant may then begin writing/drawing/or making changes to the contents of the board as the virtual meeting proceeds.

This approach to sharing the board's content, however, does not always produce optimal results. For example, the camera may be positioned too far from the board or may be oriented improperly with respect to the board. In another example, the board may be positioned in a dark area of the camera's field of view or the board may reflect a light creating glare in the image. Additionally, when the participant tries to edit the contents of the board, he/she may block a part of the board, such that other participants cannot view the entire contents of the board until the participant sharing the board moves out of the way. As a result, the images of the board provided to the other participants may be difficult to see and read.

Hence, there is a need for improved systems and methods of providing video streams containing a target.

### SUMMARY

In one general aspect, this disclosure presents a device having a processor and a memory in communication with the processor wherein the memory stores executable instructions that, when executed by the processor, cause the device to perform multiple functions. The function may include receiving a video stream captured by a camera positioned to include a target in a camera field of view and receiving a first signal to enter a detection mode to detect the target in the received video stream. Responsive to the received signal, the device may detect the target in the video stream and upon detecting the target in the video stream, automatically switch from the detection mode to an enhancement mode configured to process the video stream to obtain an enhanced video stream of the detected target. The enhanced video stream may then be presented for display on a display device, while a position of at least one of the camera or the target is monitored while presenting the enhanced video stream for display. The device may then detect a change in the position of at least one of the camera or the target, and upon detecting the change in the position, automatically generate a second signal to switch back to the detection mode and detect a position of the target in the video stream.

In yet another general aspect, the instant application describes a method for providing an enhanced video stream. In one implementation the method may include receiving a video stream captured by a camera positioned to include a target in a camera field of view and receiving a first signal to enter a detection mode to detect the target in the received video stream. Responsive to the received signal, the method may include detecting the target in the video stream and upon detecting the target in the video stream, automatically switching from the detection mode to an enhancement mode configured to process the video stream to obtain an enhanced video stream of the detected target. The method may further include presenting the enhanced video stream for display on a display device, while a position of at least one of the camera or the target are monitored while presenting the enhanced video stream for display, detecting a change in the position of at least one of the camera or the target, and upon detecting the change in the position, automatically generating a second signal to switch back to the detection mode and detect a position of the target in the video stream.

In a further general aspect, the instant application describes a non-transitory computer readable medium on which are stored instructions that when executed cause a programmable device to receive a video stream captured by a camera positioned to include a target in a camera field of view and receive a first signal to enter a detection mode to detect the target in the received video stream. The instructions may further cause the programmable device to: responsive to the received signal, detect the target in the video stream and upon detecting the target in the video stream, automatically switch from the detection mode to an enhancement mode configured to process the video stream to obtain an enhanced video stream of the detected target, present the enhanced video stream for display on a display device, while a position of at least one of the camera or the target are monitored while presenting the enhanced video stream for display. The instructions may then cause the programmable device to detect a change in the position of at least one of the camera or the target, and upon detecting the change in the position, automatically generate a second signal to switch back to the detection mode and detect a position of the target in the video stream.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example environment in which aspects of this disclosure may be implemented.

FIG. 2 depicts a simplified example system architecture for optimized processing of video streams of a physical board designed for use in writing or drawing.

FIGS. 3A-3B depict example before and after images of a board designed for use in writing or drawing.

FIG. 4 is a flow diagram depicting an example method for capturing a video stream containing a board designed for writing, drawing or presentation information on, detecting the board in the video stream, and processing and presenting the video stream.

FIG. 5 is a flow diagram depicting an example method for performing optimizing processing of a video stream containing a board designed for writing, drawing or presentation information on.

FIG. 6 depicts an example environment having edges other than the board edges and having a line drawn on the board.

FIG. 7 depicts example images for before and after enhancement filtering is applied to an image.

FIG. 8 depicts multi-thread processing for optimizing processing of a video stream containing a physical target.

FIG. 9 is a block diagram illustrating an example software architecture, various portions of which may be used in conjunction with various hardware architectures herein described.

FIG. 10 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

When a participant in a video conference attempts to make use of a physical target (e.g., whiteboard, chalkboard, cardboard, paper, etc.) at the participant's location during the conference, the images sent to the other participants are not always readable. For example, the image of the target may be too dark, it may contain glare, it may be too small (e.g., the board is too far from the camera), it may be aligned at an angle with respect to the camera, the participant may be blocking a portion of the target, and the like. As a result, the remaining participants in the conference may have a difficult time viewing and/or reading the contents of the target. The participant may then have to move their camera, change the lighting of the room, verbally explain the content of the target and/or take other steps to address the problem. This may result in the technical problems of valuable conference time being dedicated to improving the video instead of discussing the intended issues and may thus cause inefficiency and an unpleasant user experience.

To address these issues and more, in an example, this description provides technical solutions for detecting a target such as a physical board used for writing/drawing in a video stream and processing the video stream to optimize the image of the target once the target is detected. This may involve providing a detection mode and an enhancement mode. During the detection mode, the physical target may be detected in the video stream. Once the target is detected and is determined to be stable, the solution may automatically switch to the enhancement mode for processing the video stream to obtain an enhanced video stream. In one implementation, the processing includes zooming in on the target, straightening out any perspective, and increasing the quality of the video. Such processing can include segmenting any persons occluding the target and rendering them with transparency so that the content behind them is readable, among many other enhancements. The processing can be executed in real-time, such as on a portable computing device. In some examples, such processing can be executed using a camera configured to capture video and a computing device. The processing may include utilizing machine-learning (ML) models to train ML models for improving the quality of a video stream which includes the target. As a result, the technical solution provides an efficient method of automatically detecting a physical target in a video stream and improving quality of the video stream of the target.

As will be understood by persons of skill in the art upon reading this disclosure, benefits and advantages provided by such technical solutions can include, but are not limited to, a solution to the technical problems of low quality video streams of a board designed for writing/drawing which may result in an inability to read/view the content of the board. Technical solutions and implementations provided here optimize the processing of video streams containing a physical target designed for writing/drawing by automatically detecting the target and training ML models to improve the detection of the target and quality of the video stream. The benefits provided by these solutions provide improved quality of video streams, increasing efficiency and accuracy during video conferencing, and improving user experience.

As a general matter, the methods and systems described herein may relate to, or otherwise make use of, machine-trained models. ML generally involves various algorithms that can automatically learn over time. The foundation of these algorithms is generally built on mathematics and statistics that can be employed to predict events, classify entities, diagnose problems, and model function approximations. As an example, a system can be trained in order to identify patterns in user activity, determine associations between various datapoints and make decisions based on the patterns and associations. Such determination may be made following the accumulation, review, and/or analysis of data from a large number of users over time, that may be configured to provide the ML algorithm (MLA) with an initial or ongoing training set.

In different implementations, a training system may be used that includes an initial ML model (which may be referred to as an “ML model trainer”) configured to generate a subsequent trained ML model from training data obtained from a training data repository. The generation of this ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying ML algorithms may be trained, such as, but not limited to, decision trees, random decision forests, neural networks, deep learning (for example, convolutional neural networks), support vector machines, regression (for example, support vector regression, Bayesian linear regression, or Gaussian process regression). As another example, size or complexity of a model may be varied between different ML models, such as a maximum depth for decision trees, or a number and/or size of hidden layers in a convolutional neural network.

Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the models used by the system can be revised or regenerated to reflect the updates to the training data. Over time, the training system (whether stored remotely, locally, or both) can be configured to receive and accumulate more and more training data items, thereby increasing the amount and variety of training data available for ML model training, resulting in increased accuracy, effectiveness, and robustness of trained ML models.

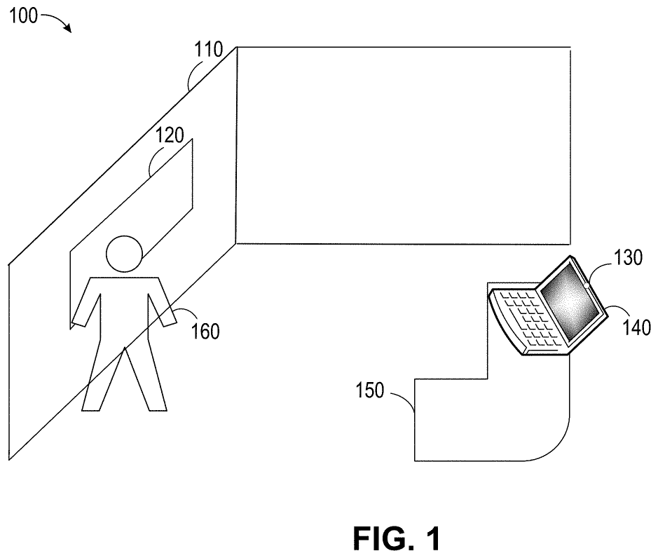

FIG. 1 illustrates an example environment 100 in which aspects of this disclosure may be implemented. The environment 100 may include a wall 110 on which a board 120 is located. The board 120 may a whiteboard, a chalkboard, glass board, flipchart board, cork board, cardboard or any other kind of board or screen used for writing, drawing, and/or presenting information on. In one implementation, the board 120 may simply be a piece of paper used for writing or drawing. Although, the board 120 is shown as being attached to (e.g., installed) on the wall 110, the board 120 can be a free-standing board having legs or a frame. Other types of configurations are also contemplated.

The environment 100 may also include a computer client device 140 having a camera 130 for capturing a video stream of the environment 100. In one implementation, the computer client device 140 is a laptop computer positioned on a desk 150. The camera 130 may be a webcam or any other type of camera designed to capture and/or process images and/or video streams and transmit the captured images and/or video streams via a computing device connected to a network to other devices. Although, camera 130 is shown as being a part of the computer client device 140, it may be a separate camera connected to the computer client device 140 (e.g., via a wired or wireless connection). In one implementation, the camera 130 may be positioned in front of the board 120 to enable the camera to capture a video stream of the board 120. The user 160 may be a user of the computer client device 140, camera 130, and/or board 120. In an example, the user 160 may use the camera 130 to transmit a video stream of the board to one or more remote users. Although, shown as a laptop computer, the computer client device 140 could be any computer device connected to or having a camera. For example, the computer client device 140 could be a mobile telephone; smart phone; tablet; phablet; smart watche; wearable computer; gaming device/computer; television; and the like.

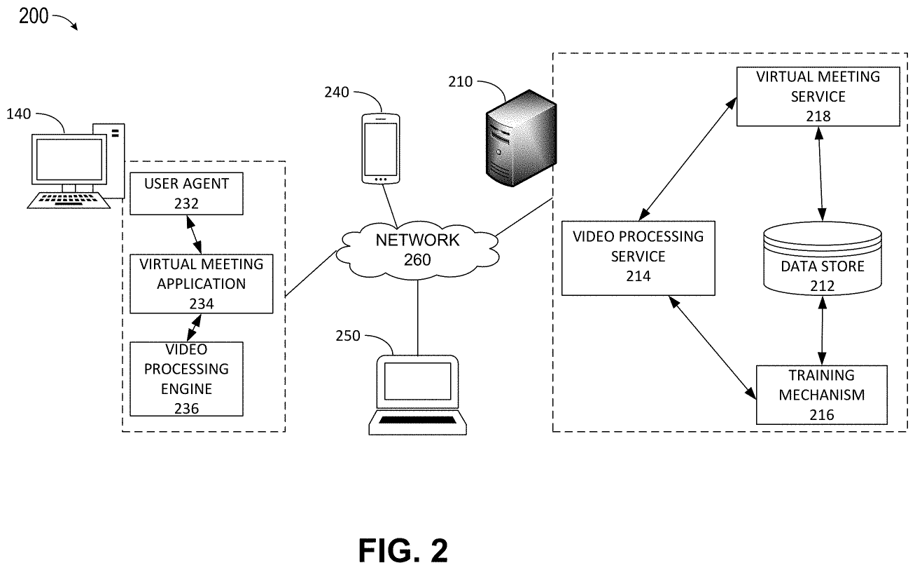

FIG. 2 illustrates a simplified example system 200 for optimized processing of video streams of a target designed for use in writing, drawing, or presenting information. The system 200 may include a server 210 which may be connected to or include a data store 212 that may function as a repository in which datasets used for training ML models may be stored. The server 210 may operate as a shared resource server located at an enterprise accessible by various computer client devices such as client device 140, 240 and 250.

The server 210 may also operate as a cloud-based server for video processing services in one or more applications or services such as virtual meeting service 218 or virtual meeting application 234. The server 210 may also include and/or execute the virtual meeting service 218 which may provide virtual meeting (e.g., video conferencing) functionality offered through an on-line service or provide functionality for connecting one or more client devices utilizing virtual meeting applications. For example, the server 210 may receive signals from one or more meeting participants utilizing a client device and transfer those signals to the other participants. The signals may be audio, video or other data signals. For example, the server may receive video signals from each of the client devices and transmit those signals to other devices in the virtual meeting to enable the participants to see each other and/or each other's physical environment (e.g., a physical target).

The system 200 may also include a presenter client device 140 and multiple participant client devices 240 and 250 which may include or have access to a virtual meeting application that enables users of each device to participate in virtual meetings. The presenter client device 140 may transmit video streams of a target to present information to the other participants via the virtual meeting application 234. The virtual meeting application 234 may make use of a video processing engine 236 or the video processing service 214 to detect the target and optimize the processing of the video streams before they are transmitted. It should be noted, that although client device 140 is labeled as a presenter device and client devices 240 and 250 are labeled as participant devices, each of the client devices 140, 240 and 250 may become a presenter during a virtual meeting.

The training mechanism 216 may use training datasets stored in the datastore 212 to provide initial and/or ongoing training for ML models used in the video processing service 214. In one implementation, the training mechanism 216 may use labeled training data from the datastore 212 to train the ML models. The initial training may be performed in an offline or online stage.

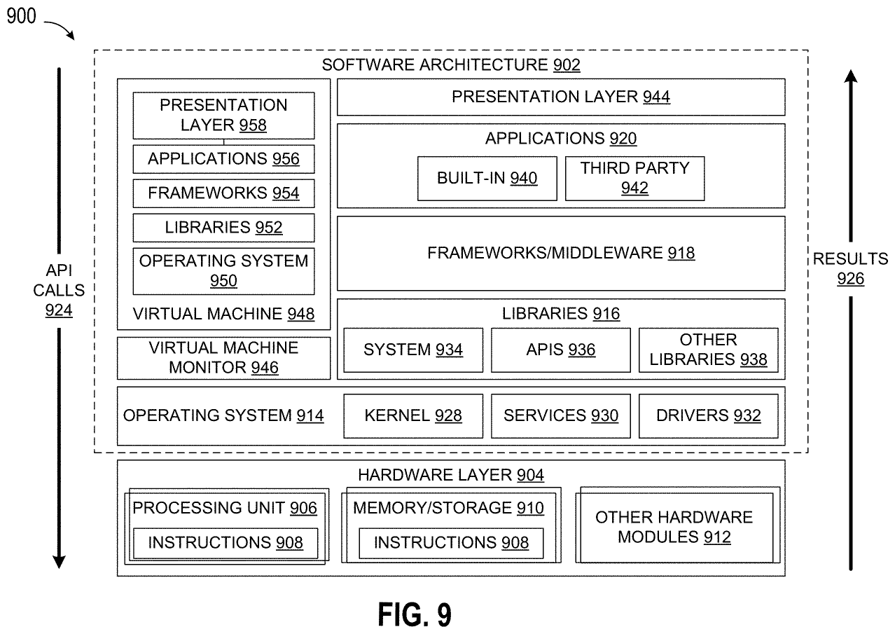

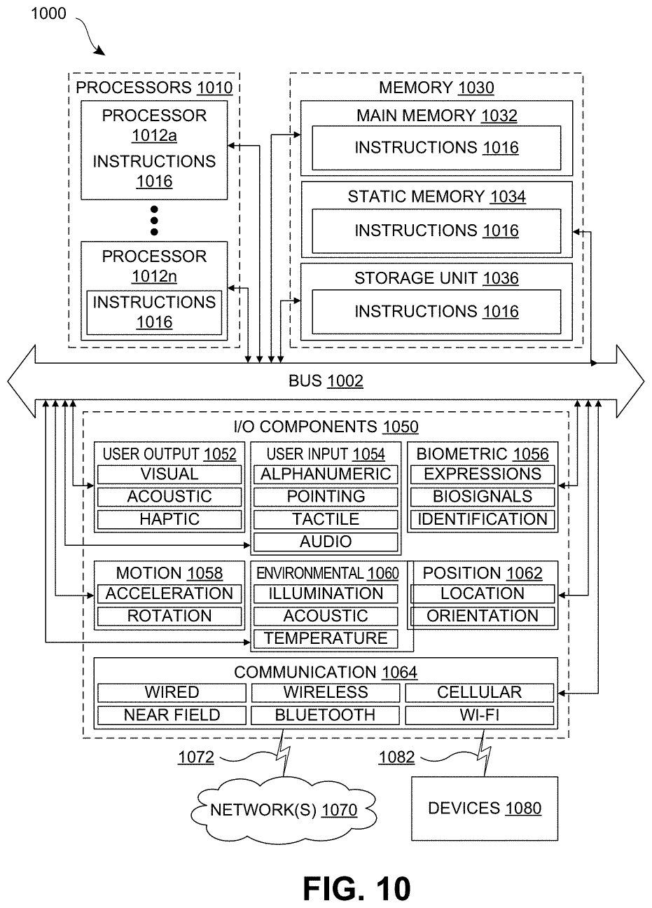

The client devices 140, 240 and 250 may be connected to the server 210 and/or to each other via a network 260. The network 260 may be a wired or wireless network(s) or a combination of wired and wireless networks that connect one or more elements of the system 200. The client devices 140, 240 and 250 may be personal or handheld computing devices having or being connected to input/output elements that enable a user to interact with various applications (e.g., application 234) and services (e.g., services 214 and 218). Examples of suitable client devices 130, 240 and 250 include but are not limited to personal computers, desktop computers, laptop computers, mobile telephones; smart phones; tablets; phablets; smart watches; wearable computers; gaming devices/computers; televisions; and the like. The client devices 140, 240 and 250 may include or be connected to a camera for capturing and/or transmitting a live video stream. The internal hardware structure of a client device is discussed in greater detail in regard to FIGS. 9 and 10. It should be noted that client device 140 is representative of one example client device for simplicity. Many more client devices may exist in real-world environments.

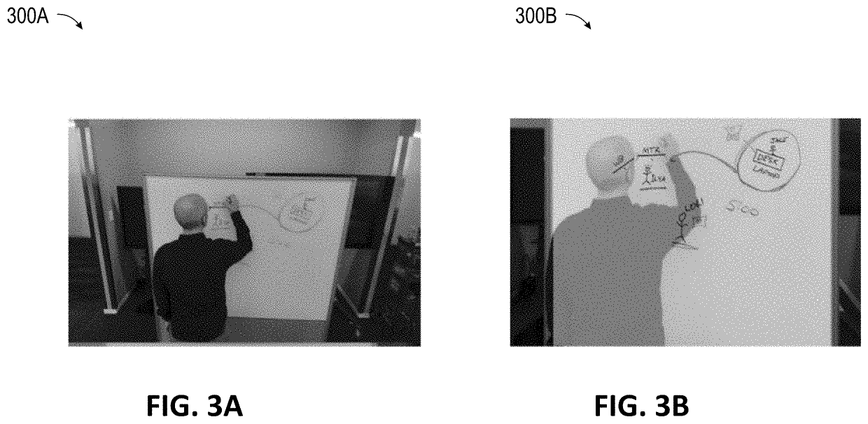

FIGS. 3A-3B depict example before and after processing images of a board used for writing or drawing. FIG. 3A depicts an unprocessed image 300A of a whiteboard used by a person to write/draw on. In one example, the image 300A may be received via a webcam and be transmitted as part of a video stream during a video conference. As shown, the content of the image 300A may be difficult to view and read. First, the whiteboard is located in the bottom half of the image and as such as is not centered. That means the camera may be located at an angle with respect to the board. Second, the image is too small (e.g., the camera is too far from the whiteboard). Third, the person writing on the whiteboard is blocking a portion of the board making it impossible to view the blocked portion of the whiteboard.

FIG. 3B depicts an after being processed image 300B of the whiteboard of image 300A. As can be seen, in image 300B the whiteboard is centered, the image is zoomed in to the whiteboard to display the contents more clearly, and the person's image is made transparent to make the blocked content of the board viewable. As a result, the processed image 300B is much more readable than the original image 300A.

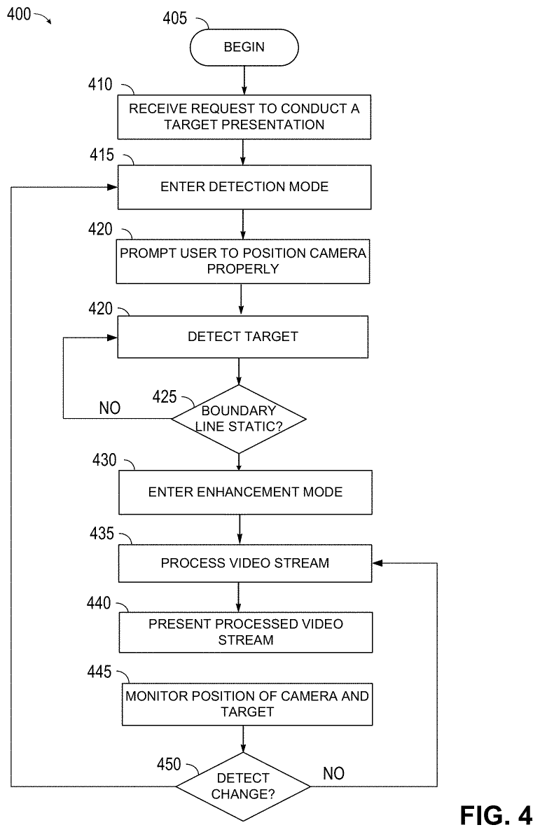

FIG. 4 is a flow diagram depicting an example method 400 for capturing, processing and presenting a video stream containing a target designed for writing, drawing or presentation information on. The method 400 may begin, at 405, and proceed to receive a request to conduct a target presentation. In one example, the request may be a signal received via a user interface control of a video conferencing application. For example, during a video conference, a participant may decide to utilize a board present at their location to present some information to the other participants. As a result, the user may utilize a user interface control (e.g., a menu button) of the video conferencing application or service to generate a signal to initiate a board presentation.

Alternatively, the request may be initiated directly from the video conferencing application. For example, the video conferencing application may process the video stream to identify an object resembling a board and thus automatically determine that the presentation will include a board presentation. In such an implementation, upon determining that the presentation will include a target presentation, method 400 may automatically enter a detection mode, as described further below. In a non-video conferencing implementation, the request may be made via a webcam application or any other application configured to receive captured video, process the captured video and transmit the processed video stream. The video stream may be captured by a camera connected to a computing device. In an implementation, the request to conduct a board presentation may initiate video capture. For example, during voice conference where a video stream is not being transmitted, receiving a request to initiate board presentation may turn on a camera connected to the client device to begin capturing video.

Upon receiving the request, method 400 may proceed to enter a detection mode, at 415. In one implementation, in the detection mode, method 400 may guide the user through a calibration process. In one implementation, the calibration process may include prompting the user to position the camera properly with respect to the board, at 420. In one implementation, this may be done by presenting a live image of the board to the user and asking the user to ensure that the board is in the field of view of the camera and the camera is aligned properly with the board. The user may utilize the image as a guide to determine how the camera needs to be moved in order to capture the board more fully. In another example, a user interface element may be presented to the user that guides the user on how to position the camera. For example, the user interface may prompt the user to move the camera up, down, to the left or the right to fully capture the board. This may be done by capturing an image of the board via the camera and processing the image to identify the location of the board in the image. If the board is not in the field of view of the camera, is determined to be not centered in the image or if it is determined that only a portion of the board was captured, method 400 may determine how the camera would need to be moved to capture the whole board. The processing mechanism used for identifying the board and determining how to move the camera to capture a better image will be discussed in more details below.

Once the camera has been properly positioned with respect to the board (e.g., the user indicated via a user interface element that proper positioning has been achieved or the system determines that the image fully captures the board), method 400 may proceed to detect the target (e.g., board) in the current video stream, at 425. In one implementation, this may include visually presenting the progress of identification of the board on a user interface by for example dynamically drawing boundary lines of the board reflecting the progress of identification on the presented video stream. For example, boundary lines may be drawn around the identified target on the video stream. This may help the user determine if the target is being correctly identified. In an example, the user may be able to indicate via a user interface element whether the method correctly identified the board. In one implementation, a progress bar may be shown on the use interface identifying the progress of the detection. As the target or the camera are moved during the calibration process the drawn boundary lines may be redrawn to reflect the process of detecting the target. In one implementation, animation may be used to draw the boundary lines gradually. For example, one of the identified corners of the target may be selected as a starting point for the boundary lines and the lines may be drawn progressively from the starting point to a finishing point.

Upon determining that identification of the board is complete, method 400 may proceed to determine if the identified boundary line around the target is static for a threshold amount of time, at 425. This may be done to ensure that the calibration process is complete, the target and/or the camera are no longer moving (e.g., they are stationary), and the board has been detected correctly. For example, if either the camera or the target is moved during the threshold amount of time, the method may begin redrawing the boundary lines. Thus, method 400 may determine that the boundary line has not been static during the required threshold amount of time. If it is determined that the boundary line has not been static, at 425, method 400 may return to step 420 to detect the target.

Once it is determined that the boundary line has been static for the threshold amount of time indicating that both the target and the camera are stationary, method 400 may automatically enter an enhancement mode, at 430. In one implementation, this may involve performing one or more actions that notify the user that the detection is complete. In an example, this may include gradually removing the drawn boundary lines around target by for example fading the lines. In another example, it may include providing an audio notification to the user. The audio notification may be a beep, a shutter sound or spoken words stating that the target has been identified.

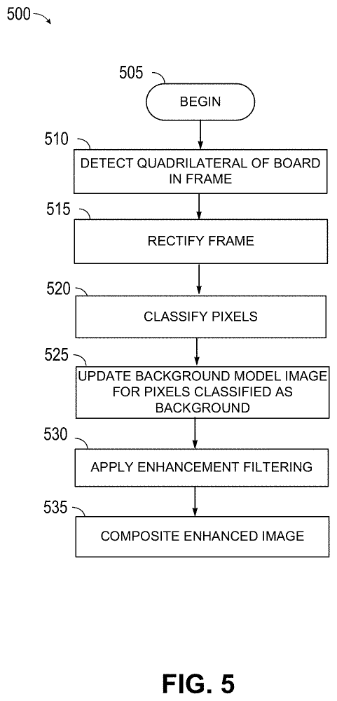

Upon entering the enhancement mode, method 400 may further process the video stream to improve the quality of the presentation, at 435. The processing mechanisms used for further processing the video streams are discussed in more details with respect to the flow diagram of FIG. 5. Once the video stream is further processed to improve its quality, the processed video stream may be presented to a user, at 440. For example, the processed video stream may be displayed on a client device of the user initiating the presentation and/or client devices to which the presenter's client device is connected to enable remote users to view the target as part of the presentation.

After presenting the processed video stream, method 400 may continue monitoring the position of the camera and the target, at 445. This may be done to ensure that the position is stationary and has not moved. In an implementation, the position may be monitored by determining if a change in coordinates of the identified target has occurred between two subsequent frames in the video stream. For example, pixels at one or more edges of the target may be monitored to determine if there is a change. This may involve determining which edges are most likely to remain the same between different frames. For example, if a person is covering the right edge of the target, the right edge may not be selected for determining change in position. Thus, method 400 may determine if there is a change in coordinates of one or more identified pixels in subsequent frames of the video stream during a predetermined amount of time. The one or more identified pixels may be pixels that are not likely to change from frame to frame.

Thus, method 400 may determine, at 450, if a change in the position of the camera or the target has been detected. When it is determined that the both the camera and the target have remained stationary, method 400 may return to processing the video stream, at 435. However, if it is determined that one or both of the camera or the target have moved, method 400 may generate a signal to switch back to the detection mode and detect the position of the target in the video stream, at 420. Upon redetection of the target, method 400 may draw updated boundary lines around the target on the user interface.

FIG. 5 is a flow diagram depicting an example method 500 for performing optimized processing of a video stream containing a physical target designed for writing, drawing or presentation information on. The method 500 may begin, at 505, and proceed to detect the quadrilateral (e.g., edges and corners) of any target detected in the video frame. Depending on the environment in which the target is located, this may be challenging because there may be missing or occluded edges and corners, there may be heavy reflection on the board, there may be other rectangular objects in the scene, and the like. To ensure a high-level understanding of the scenes in which a physical target such as a board may be present, in one implementation a trained ML model may be used. For example, a deep convolutional neural network for semantic segmentation of board pixels may be trained and used as part of the process. The input to the network may be color images and the output may classify each pixel in the color image into one of three classes: foreground, board, or background. The foreground may consist of persons, chairs and other occluding objects. The background may consist of photos of the board but also of synthetic images generated in a ray-tracing application.

In one implementation, the deep convolutional neural network may be a network that has an encoder-decoder structure with shortcut connections between corresponding pyramid levels. Details of such encoder-decoder structures are discussed by Sandler et al “MobileNetV2: Inverted Residuals and Linear Bottlenecks”, The IEEE Conference on Computer Vision and Pattern Recognition (CVPR), 2018, pp. 4510-4520, entirety of which is incorporated by reference herein. In an example, the input image may be down-sampled (e.g., 288×160 pixels). As a result, the trained network may output a classification map of the same resolution.

The classification map may then be used to locate edges in the image. Edges between background and the board may be kept, whereas edges to foreground objects may be ignored. The rough direction of each edge pixel may then be computed, separating edges into the four main board edge directions (top, right, down, left). For each direction, a random sample consensus (RANSAC) line fitting operation may then be performed. The intersections of the located edge directions may then be computed to form a first estimate of the board's quadrilateral. Edges outside this quadrilateral may be removed and line fitting may be performed iteratively, as needed, for a more accurate estimate.

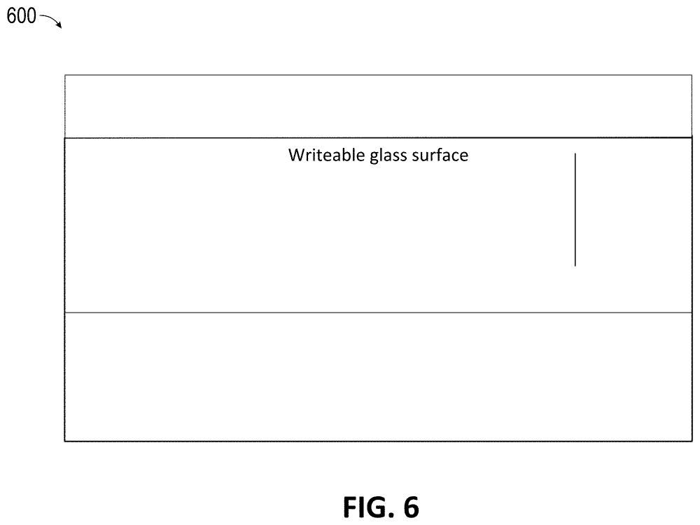

The use of a deep convolutional neural network approach as described above can provide improved edge detection by better distinguishing board edges from other edges in the image (e.g., wall corners, lines drawn on the board, patterns on the floor and the like). FIG. 6 depicts an example of an environment 600 having edges other than the board edges and having a line drawn on the board. In the environment 600, a previously used edge detection technique (e.g., one that does not make use of a trained ML model) detected the lower edges of the glass as the lower edge of the board.

It should be noted that in some implementations, step 510 of method 500 may not need to be performed on every frame. For example, once the quadrilateral edges of the board have been detected, the same transform can be used for all consecutive frames in the video stream.

After the quadrilateral edges of the board have been detected, method 500 may proceed to rectify a received frame, at 515. In one implementation, this may be achieved based on the identified 2D quadrilateral edges of the image by using a mechanism to estimate the physical aspect ratio of the board and to compute the perspective transform homography from the input image to the rectified image. The rectified image may then contain the board as a rectangle scaled to fill the output video stream as much as possible without cropping the board. In an example, this is done by using the mechanism discussed by Zhang and He, “Real-Time Whiteboard Capture and Processing Using a Video Camera for Teleconferencing”, https://www.microsoft.com/en-us/research/wp-content/uploads/2016/02/tr-2004-91.pdf, the entirety of which is incorporated by reference herein.

Assuming that the camera is stationary, this homography estimation may only need to be performed once. Subsequently, for each new frame, the input image may be bilinearly resampled according to the computed homography estimation. This is known in the art as warping or texture mapping. It is common for GPUs to have dedicated hardware to perform texture mapping efficiently. However, the method for optimized processing of a video stream containing a board discussed herein may also make use of a CPU in order to enable the method to be executed on as many platforms as possible.

Commonly used methods of homography transformation may require two expensive division operations per pixel. This could be avoided by pre-computing the transform for all pixels. However, such a pre-computed warp map may require a substantial amount of memory. To avoid the need for a significant amount of memory, in one implementation, the homography is estimated with a grid of affine transform. The affine transform may require fewer operations in general and no divisions.

A webcam may vibrate or otherwise move during acquisition. Without compensation for this, the background modeling described below may provide a blurred image. To address this, the corresponding displacements in the image may be detected by small local searches using normalized cross correlation or similar techniques. In an example, these local correlations give a motion vector each. From these vectors, a fine-tuned homography transform may be computed for each frame, ensuring that the warped result appears stationary despite camera vibration. Because the time-consuming warping may need to be performed on each image, this vibration compensation may not require any additional resources.

In one implementation, method 500 may also include classifying pixels in a received frame as background or foreground pixels, at 520. This may be achieved by a trained ML model similar to the trained ML described above for semantic segmentation of board pixels. However, the trained ML model for segmentation at this stage may include two classes of background and foreground instead of the three classes discussed above. This model may be referred to as the background segmentation model. The training data for the background segmentation model may include synthetically generated images by compositing photos of boards and photos of persons in front of a screen and/or real images of persons in front of a board. The ML model may then be applied to the training data and labeling mistakes may be corrected (e.g., manually) to train the model.

After applying the trained background segmentation model to the received image to classify the pixels, the background segmentation model may be updated for the pixels classified as background pixels, at 525. This may be done to replace the pixels in the board that are occluded by a person or another object with pixels from previous images that include the content of the board. For example, for pixels occluded by a person, an image that contains the last seen contents of the board may be used. In an example, an infinite impulse response (IIR) filter may be used to update the pixel value using (1−α) of the new value and a of the old:

gₜ(x,y,=gₜ₋₁(x,y,c)·α+f(x,y,c)·(1−α) (1)

In formula (1), g may refer to the background model, f may refer to the input image, t may refer to the frame index and c may be used to refer to the color channel. In an example, α may be a variable the value of which may be predetermined for example by experimentally determining an optimal value to use. In one implementation, α=⅞ may be used. This would mean that a change may need five frames to contribute approximately 50% to the background model and 17 frames to reach approximately 90% impact. In this manner, the filtering may introduce both latency and denoising. The above formula can be applied to the pixels classified as background. By using in the foreground mask m to leave the foreground-classified pixels unchanged, formula (1) may be change as follows:

gₜ(x,y,c)=gₜ₋₁(x,y,c)−(1+(α−1)·m(x,y))+f(x,y,c)·(1−α)·(1−m(x,y)) (2)

In an example, the mask m computed by the segmentation above may be in the range [0, 1].

In some examples, the IIR filter may not be robust against outliers. If the segmentation fails for some pixels, the foreground color can leak into the background image with (1-a) per frame. In an implementation, a more sophisticated model, such as a Gaussian mixture model or a running temporal median filtering may be used to ignore outliers. This may be achieved at the cost of additional memory and computation. The IIR approach may require no additional storage than g itself which may use about 3 bytes per pixel.

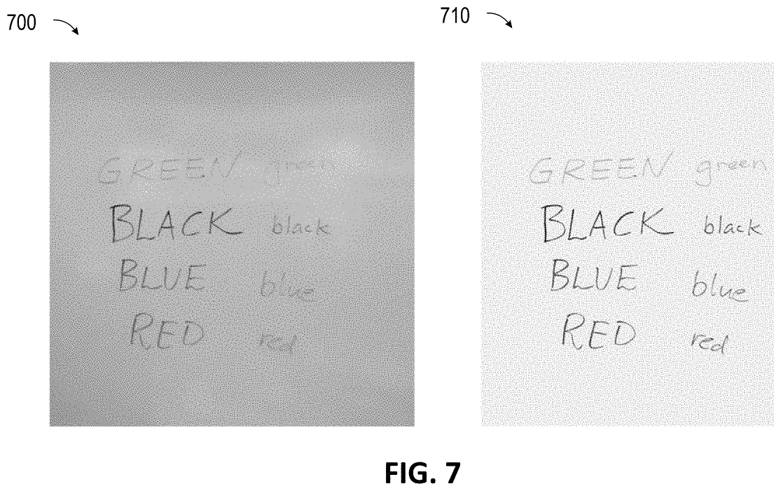

Once the image has been updated to account for occluded pixels, method 500 may proceed to apply enhancement filtering to the image, at 530. Enhancement filtering may include removing reflections, improving the contrast, making colors distinct, sharpening blurred images, removing stroke reflections on glass boards, denoising, and more. FIG. 7 provides example images 700 and 710 showing before and after enhancement filtering was applied to an example image. Image 700 depicts an image being somewhat blurry and having reflections. Image 710 depicts how the quality of the image may be improved after enhancement filtering has been applied to the image.

In one implementation, enhancement filtering may be applied by using a trained ML model. For example, a deep convolutional neural network may be trained by using a synthetic dataset (e.g., a purely synthetic dataset) of common board content. In an example, the ground truth can be generated by rendering clean, sharp strokes of random pen colors on a flat white background. Each such image can then be distorted to generate the corresponding input image. The distortions can simulate common image issues encountered in images containing boards and may include adding noise, modifying hue, modifying saturation, modifying brightness, modifying color temperature, modifying contrast and gamma curves, simulating reflections by blending in photos of office interiors, simulating stroke reflections on glass boards by mixing in an offset copy of the stroke, and simulating lens defocus by blurring. The distorted input images may then be fed to the model to train it.

The enhancement filtering can be a generative convolutional neural network. This means that the model outputs images. In one implementation, the model may output RGB values and train the network to match these RGB values to the ground truth RGB using an L1 or L2 loss function. In contrast to the segmentation problem of foreground segmentation above, this can be a regression problem. The regression may have no restrictions on the output, so it may generate any color outside the range of whiteboard pen colors. For example, rainbow artifacts may appear along the edges of some strokes when training with an RGB regression loss.

To address this, a different approach may be taken. The approach may involve assuming a palette of a number of pen colors, and letting the network classify each pixel into one of these classes. The board background can be added be as an additional class. This is a multi-class segmentation problem, normally solved with a cross-entropy loss. For each pixel, the class with highest output may be selected and the pixel may be colored with the corresponding pen color. This winner-takes-all approach guarantees that only the pen palette colors are used in the output. However, when the classification fails there can be artifacts with abrupt changes in color. In an implementation, the annealed mean may be used to mix the colors of several pens to reduce these artifacts.

In some cases, the classification approach may require that the pen color palette be defined at training time. This may include both the number of colors and the color values. Different manufacturers of dry erase markers may have slightly different colors. A pen with a color halfway in-between two colors in the trained palette is likely to give a non-distinct classification result. In an example, it may be preferable to get the same pen indices over the full image even if the illumination is not uniform. Consequently, the classification may take global information from the full image into account. A feature map attention method can be used for this purpose. Intuitively, the network should learn to classify which pens out of the full pen palette are in use in the current video.

In order to get clear stroke boundaries, a separate model can be trained with the mask output channel in addition to the color classification channels. The mask value can determine how much of the pen color should be mixed into the white background. It can be thought of as how much of the pixel is covered by the stroke. For most pixels, the mask has a value of zero (background) and for most stroke pixels it has the value of one. For pixels at the edge of the stroke, the mask may have values in-between zero and one. The mask may be trained with a L1 or L2 loss, so that the convolutional neural network learns how to render these stroke edges accurately.

In one implementation, instead of using the classical losses (e.g., L1, L2, or cross-entropy), the training can be formulated as a conditioned Generative Adversarial Network (GAN) as known in the art. In addition to being a GAN, this approach may also introduce a discriminator network which may be used during training. The discriminator network may be used to learn how to distinguish the generator output from the ground truth images. Since the discriminator network is a deep neural network, it may be able to learn loss functions such as punishing color change along strokes, encouraging uniform width along strokes, encouraging similar stroke curvatures as in the ground truth and encouraging clear edges.

As one of the main goals of applying enhancement filtering is to increase readability, an optical character recognition (OCR) engine may be used to read the text on the output images during training and include the OCR confidence value as an additional loss term. This can train the model to produce more readable results. In an example, the OCR confidence may correspond well to human readability to further increase readability of the contents of the board. OCR and shape recognition (e.g. boxes, circles, arrows) may also be performed on the content of the received image. In an example, once text and/or shapes are recognized in the image, the content can be exported as text and/or vector graphics that can be manipulated in other applications. For example, handwritten text can be replaced with typed characters of a desired font and hand drawn shapes can be converted to standard shapes with proper alignment.

The input to a computer vision network is often in RGB format. However, in video coding, often the YUV format is used, where the Y channel encodes luma (intensity) and U and V encode chroma (color). The color information is often subsampled by a factor of two in both x and y since the human eye also has lower resolution for chroma than for luma. Such a subsampling can be used for the enhancement filtering discussed above. The luma channel, at full resolution, may be used to generate the mask, while chroma, at a lower resolution, may be used to compute the pen colors. This can reduce the amount of computation at full resolution, which may be computationally the most expensive part of the network.

The enhancement filtering, discussed above, may be computed on the full image resolution. This may take more time than performing segmentation inferences which operate on a lower resolution. In some examples, the content of the board may be updated slowly, stroke by stroke. In such examples, there may not be a need to recompute the enhancement on the full image for each frame. To improve the speed, the image may thus be divided into grid cells and a fast change detection may be performed to determine if there is any new content in a cell. Enhancement filtering may then be performed on changed cells and on cells that have not been updated in a given period of time. The enhanced result may then be blended with some overlapping feathering to neighboring cells in order to not reveal the grid pattern.

Change detection may be made by comparing the latest frame with the background model. Since there can be a latency of around 10 frames for the new content to appear in the background model, the detected changes may be queued for a fixed number of frames. Enhancement filtering may then be applied, once the change is visible in the background model image.

Referring back to FIG. 5, once enhancement filtering is complete, method 500 may proceed to composite the enhanced image with the input image as the output shown to the user, at 535. As a result, persons or objects in the foreground may appear semi-transparent. The amount of transparency can be a tradeoff between readability of the board content and seeing the expressions of the person. Compositing can use the segmentation mask, discussed above, as the input to provide different alpha blending factors for different pixels. Background pixels can then show the enhanced background at full strength and only perform blending on the foreground areas of the image. However, this approach may result in misclassifications in the segmentation becoming clearly visible.

To address this, an alternative solution may be used to blend the two images with a constant alpha factor independent of the segmentation mask. Using this technique, background areas of the image can be composited as a mixture of the input image and the enhanced image. This can reduce the effect of artifacts in enhancement filtering. One common artifact is that weak thin lines may not survive enhancement filtering at all. With the constant blending, such a line would still blend in. Another advantage of the constant blend approach is that segmentation may be needed for the background modelling and not for compositing. When using different threads for foreground and background processing, segmentation can be moved to the background processing, reducing the computation of the foreground processing and thereby improving the foreground frame rate.

Referring back to step 510 of FIG. 5, during the calibration stage, the found quadrilateral may be visualized in the image. This may allow the user to adjust the camera to get a good view of the board. When quadrilateral detection is stable for a period of time (e.g. two seconds), quadrilateral detection may be disabled, while other processing steps are enabled. When warping is enabled, to avoid an abrupt transition, a quick smooth transition of the homography, from the unit homography to the estimated one may be performed. This may provide the illusion of quickly moving the camera to a centered position straight in front of the board. During operation, method 500 may also seek to detect camera movements. Small movements may be handled by the vibration compensation techniques described above. For larger movements, method 500 may re-enter the detection mode for performing a new quadrilateral detection.

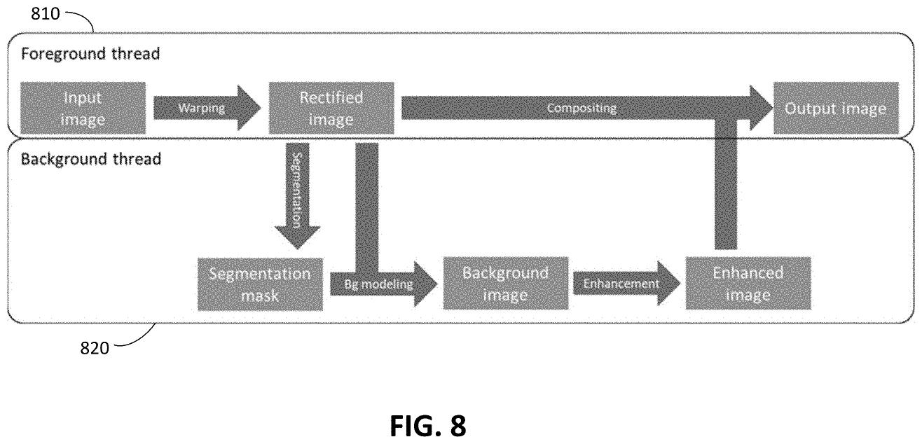

Some of the processing steps discussed above can be performed in sequence and others can be performed in parallel. As a result, the processing steps can be separated into two threads, which may be referred to as foreground and background. This is illustrated in FIG. 8. In one implementation, the foreground thread 810 may warp the image and perform compositing with the most recent enhanced background image, while the background thread 820 may take the warped image and perform person segmentation, background modeling and enhancement filtering. These processing steps can be computationally more expensive than the foreground thread. As a result, in one implementation, some warped images may not be processed by the background thread. This can be done because background content often changes slowly over time. The foreground thread is usually faster and can thus process the image to show for example a person's movements at a high frame rate.

In one implementation, when entering the board presentation mode, the video pipeline is configured as video-based screen sharing. This may favor high quality encoding and high resolution over high frame rate. In an example, it may also force the receiving clients to display the processed board video in full screen.

Some cameras have motors for pan, tilt and zoom (PTZ). In one implementation, these motors may be controlled to zoom in on the detected board. This optical zoom and mechanical pan/tilt can increase the quality compared to the digital warping described above. Other cameras have an image sensor of higher resolution than the output stream from the camera and support digital PTZ inside the camera. This can increase image quality in a similar manner as mechanical PTZ. While controlling the pan, tilt and zoom motors, board quadrilateral detection can be performed on the video during the transition to dynamically guide the optimal PTZ values. Dynamically detecting the board can indicate when to stop zooming, panning and/or tilting.

In one implementation, the board content may be exported to other applications. To do this, a bitmap image may be used. Such an image may able to contain the enhanced rectified background without any overlay of persons. One technique for implementing this method may include having a user interface control for providing a snapshot option. Upon receiving a selection of the user interface control, the current board content may be provided as a bitmap image in a messaging portion of the virtual meeting application.

Alternatively, the decision on when to provide a snapshot of the content can be determined automatically by the system. Such an automatic key frame detection may need to determine salient events in the video. An example salient event may be that a snapshot is provided when the meeting ends. The system can also take a snapshot just before someone starts erasing a large area of the board to make room for new content. This may require detecting erasure which may be done by analyzing the enhanced image over time. A queue of enhanced frames can be used to capture the appropriate snapshot.

It should be noted that the optimized target detection and image processing may be provided as part of the virtual meeting application. As such it may be hosted locally on the client or remotely in the cloud. In one implementation, a local optimized image processing engine may be hosted locally, while others are stored in the cloud.

Thus, methods and systems for providing the technical solution of intelligent video presentation for a video stream including a physical target such as a board are disclosed. Such methods and systems can provide technical improvements and robustness in both target detection and enhancement filtering by utilizing ML models to process images. This can reduce network traffic, such as by reducing the transmission of video streams and instead transmitting vector graphic commands for drawing the target content.

FIG. 9 is a block diagram 900 illustrating an example software architecture 902, various portions of which may be used in conjunction with various hardware architectures herein described, which may implement any of the above-described features. FIG. 9 is a non-limiting example of a software architecture and it will be appreciated that many other architectures may be implemented to facilitate the functionality described herein. The software architecture 902 may execute on hardware such as client devices, native application provider, web servers, server clusters, external services, and other servers. A representative hardware layer 904 includes a processing unit 906 and associated executable instructions 908. The executable instructions 908 represent executable instructions of the software architecture 902, including implementation of the methods, modules and so forth described herein.

The hardware layer 904 also includes a memory/storage 910, which also includes the executable instructions 908 and accompanying data. The hardware layer 904 may also include other hardware modules 912. Instructions 908 held by processing unit 908 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks 918, applications 920, and a presentation layer 924. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 738 to provide many functions for applications 920 and other software modules.

The frameworks 918 (also sometimes referred to as middleware) provide a higher-level common infrastructure that may be used by the applications 920 and/or other software modules. For example, the frameworks 918 may provide various GUI functions, high-level resource management, or high-level location services. The frameworks 918 may provide a broad spectrum of other APIs for applications 920 and/or other software modules.

The applications 920 include built-in applications 920 and/or third-party applications 922. Examples of built-in applications 920 may include, but are not limited to, a contacts application, a browser application, a location application, a media application, a messaging application, and/or a game application. Third-party applications 922 may include any applications developed by an entity other than the vendor of the particular system. The applications 920 may use functions available via OS 914, libraries 916, frameworks 918, and presentation layer 924 to create user interfaces to interact with users.

Some software architectures use virtual machines, as illustrated by a virtual machine 928. The virtual machine 928 provides an execution environment where applications/modules can execute as if they were executing on a hardware machine (such as the machine 1000 of FIG. 10, for example). The virtual machine 928 may be hosted by a host OS (for example, OS 914) or hypervisor, and may have a virtual machine monitor 926 which manages operation of the virtual machine 928 and interoperation with the host operating system. A software architecture, which may be different from software architecture 902 outside of the virtual machine, executes within the virtual machine 928 such as an OS 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement methods or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” include a collection of machines that individually or jointly execute the instructions 1016.

The machine 1000 may include processors 1010, memory 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multi-core processor including cores that may execute instructions contemporaneously. Although FIG. 10 shows multiple processors, the machine 800 may include a single processor with a single core, a single processor with multiple cores (for example, a multi-core processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056 and/or position components 1062, among a wide array of other environmental sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 864 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1062, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-8) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that when executed by the processor cause the data processing system to perform functions of:
receiving a video stream captured by a camera positioned to include a target in a camera field of view;
entering a detection mode to detect the target in the received video stream;
detecting the target in the video stream;
upon detecting the target in the video stream, automatically switching from the detection mode to an enhancement mode configured to process the video stream to obtain an enhanced video stream of the detected target;
presenting the enhanced video stream for display on a display device;
monitoring a position of at least one of the camera or the target while presenting the enhanced video stream for display;
detecting a change in the position of at least one of the camera or the target; and
upon detecting the change in the position, automatically generating a first signal to switch back to the detection mode and detect a position of the target in the video stream.

2. The data processing system of claim 1, wherein for detecting the target in the video stream, the memory further includes executable instructions that when executed by the processor cause the data processing system to perform functions of:
receiving a second signal to enter the detection mode;
responsive to the received second signal, detecting the target in the video stream; and
detecting the target in a static location for a threshold amount of time.

3. The data processing system of claim 1, wherein for detecting the target in the video stream, the memory further includes executable instructions that when executed by the processor cause the data processing system to perform functions of:
identifying a boundary line around the target in the video stream;
identifying the boundary line around the target is static for a threshold amount of time; and
detecting the target upon identifying that the boundary line is static for the threshold amount of time.

4. The data processing system of claim 1, wherein detecting the change in the position of the at least one of the camera or the target includes determining if a change in coordinates of the target has occurred between two subsequent frames in the video stream.

5. The data processing system of claim 1, wherein automatically switching from the detection mode to an enhancement mode includes automatically switching from the detection mode to the enhancement mode upon determining that the target and the camera are stationary for a threshold amount of time.

6. The data processing system of claim 5, wherein to determine that the target and the camera are stationary the memory further includes executable instructions that when executed by the processor cause the data processing system to perform functions of determining if there is a change in coordinates of one or more identified pixels in subsequent frames of the video stream during the predetermined amount of time, the one or more identified pixels being pixels that are not likely to change from frame to frame.

7. The data processing system of claim 1, wherein the target is a quadrilateral object.

8. The data processing system of claim 1, wherein the executable instructions when executed by the processor further cause the data processing system to perform functions of:
upon detecting the target in the video stream, presenting for display on a user interface identification of the target in the video stream by gradually drawing boundary lines around the target.

9. The data processing system of claim 8, wherein the executable instructions when executed by the processor further cause the data processing system to perform functions of:
upon determining that the target and the camera are stationary for a threshold amount of time, gradually removing the boundary lines before presenting the enhanced video stream for display.

10. The data processing system of claim 1, wherein the executable instructions when executed by the processor further cause the data processing system to perform functions of:
presenting for display on a user interface, the redetected target by drawing updated boundary lines around the target.

11. A method for providing an enhanced video stream, the method comprising:
receiving a video stream captured by a camera positioned to include a target in a camera field of view;
entering a detection mode to detect the target in the received video stream;
detecting the target in the video stream;
upon detecting the target in the video stream, automatically switching from the detection mode to an enhancement mode configured to process the video stream to obtain an enhanced video stream of the detected target;
presenting the enhanced video stream for display on a display device;
monitoring a position of at least one of the camera or the target while presenting the enhanced video stream for display;
detecting a change in the position of at least one of the camera or the target; and
upon detecting the change in the position, automatically generating a first signal to switch back to the detection mode and detect a position of the target in the video stream.

12. The method of claim 11, wherein detecting the target in the received video stream comprises:
identifying a boundary line around the target in the video stream;
identifying the boundary line around the target is static for a threshold amount of time; and
detecting the target upon identifying that the boundary line is static for the threshold amount of time.

13. The method of claim 11, wherein detecting the change in the position of the at least one of the camera or the target includes determining if a change in coordinates of the target has occurred between two subsequent frames in the video stream.

14. The method of claim 11, wherein automatically switching from the detection mode to an enhancement mode includes automatically switching from the detection mode to the enhancement mode upon determining that the target and the camera are stationary for a threshold amount of time.

15. The method of claim 11, further comprising upon detecting the target in the video stream, presenting for display on a user interface identification of the target in the video stream by gradually drawing boundary lines around the target.

16. The method of claim 11, further comprising:
receiving a second signal to enter the detection mode; and
responsive to the received second signal, detecting the target in the video stream, wherein receiving the second signal to enter the detection mode is done automatically.

17. A non-transitory computer readable medium on which are stored instructions that when executed cause a programmable device to:
receive a video stream captured by a camera positioned to include a target in a camera field of view;
enter a detection mode to detect the target in the received video stream;
detect the target in the video stream;
upon detecting the target in the video stream, automatically switch from the detection mode to an enhancement mode configured to process the video stream to obtain an enhanced video stream of the detected target;
present the enhanced video stream for display on a display device;
monitor a position of at least one of the camera or the target while presenting the enhanced video stream for display;
detect a change in the position of at least one of the camera or the target; and
upon detecting the change in the position, automatically generate a signal to switch back to the detection mode and detect a position of the target in the video stream.

18. The non-transitory computer readable medium of claim 17, wherein the stored instructions when executed cause a programmable device to:
upon detecting the target in the video stream, present for display on a user interface identification of the target in the video stream by gradually drawing boundary lines around the target.

19. The non-transitory computer readable medium of claim 18, wherein the stored instructions when executed cause a programmable device to:
upon determining that the target and the camera are stationary for a threshold amount of time, gradually remove the boundary lines before presenting the enhanced video stream for display.

20. The non-transitory computer readable medium of claim 17, wherein the stored instructions when executed cause a programmable device to:
present for display on a user interface, the redetected target by drawing updated boundary lines around the target.
